(19) United States
(12) Patent Application Publication
(10) Pub. No.: US 2007/0294698 A1
(43) Pub. Date: Dec. 20, 2007

(54) Allocation of Resources in a Computing Device

(75) Inventors: Andrew Thoelke, Herts (GB); Dennis May, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LIMITED, London (GB)

(21) Appl. No.: 10/595,927

(22) PCT Filed: Nov. 19, 2004
(86) PCT No.: PCT/GB04/04886

§ 371 Date: Mar. 29, 2007

(30) Foreign Application Priority Data
Nov. 21, 2003 (GB) 0327261.4

(51) Int. Cl. G06F 9/46

(52) U.S. Cl. 718/104

(57) ABSTRACT

In operation of a computing device, a secure handle is allocated to a process to enable the process to use a resource allocated to another process. The secure handle ensures that the process is not able to identify the resource and that further access to the resource is inhibited after the process has terminated any use of the resource enabled by the allocation of the secure handle.

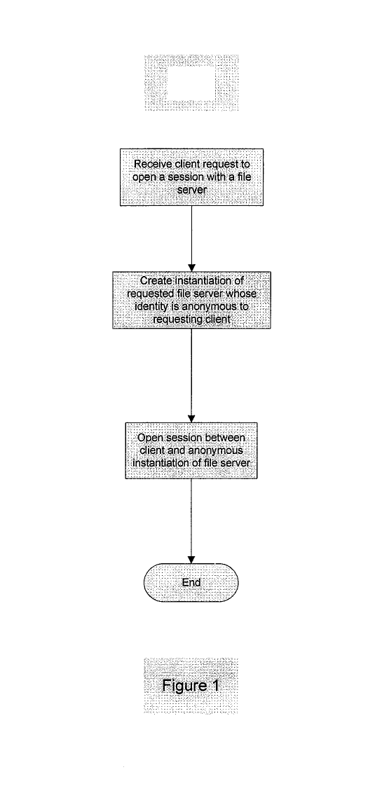

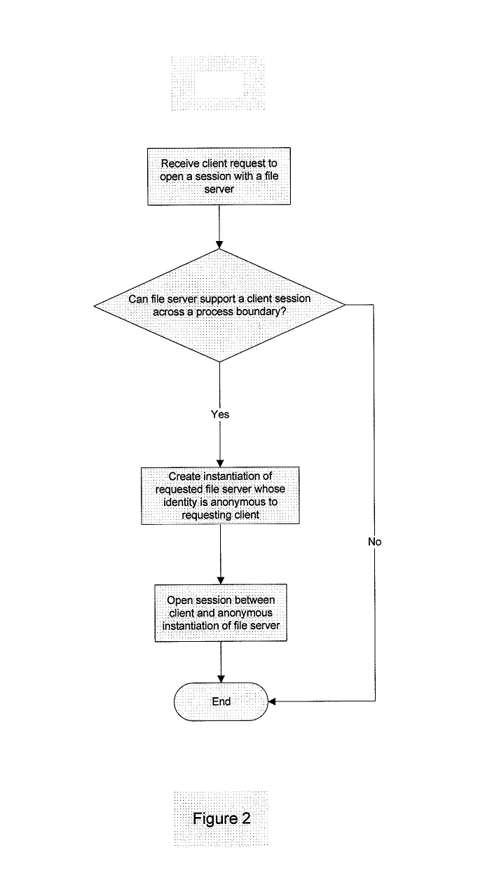

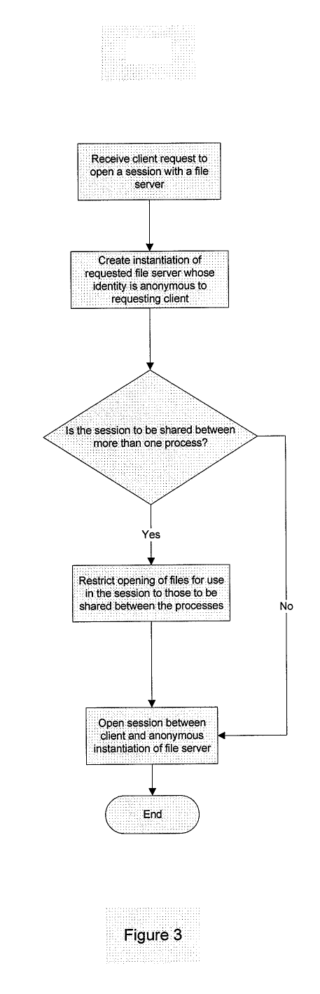

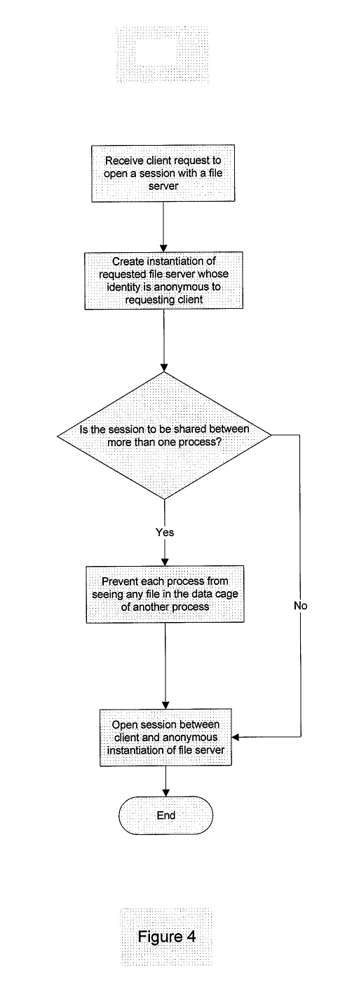

The present invention relates to a method of operating a computing device, and in particular, to a method for allocating resources for use by processes running on the computing device.

The term computing device as used herein is to be expansively construed to cover any form of electrical device and includes, data recording devices, such as digital still and movie cameras of any form factor, computers of any type or form, including hand held and personal computers, and communication devices of any form factor, including mobile phones, smart phones, communicators which combine communications, image recording and/or playback, and computing functionality within a single device, and other forms of wireless and wired information devices.

In general, computing devices are programmed to operate under the control of an operating system. The operating system controls the computing device by way of a series of instructions, in the form of code, fed to a central processing unit of the device. These instructions can be regarded as a series of quasi-autonomous fundamental units of execution which are scheduled by the operating system. These fundamental units of execution are respectively known as threads and a process to be carried out in the computing device will invariably include one or more threads. Hence, a typical operating system will schedule many different threads in order to control the variety of tasks to be carried out by the application programs of the computing device.

Many different forms of computing device are in use today, including wireless information devices in the form of smart phones. These devices operate under the control of an operating system which, in essence, is a single user operating system with a wireless connection to a telecommunications network. One example of an operating system for use with a smart phone is the Symbian OS™ operating system, provided by Symbian Limited of London, England.

With an operating system for a wireless communication device, the operating system and the client application programs to run on the device may be divided into various types of components, with different boundaries between these components. Certain of these components are commonly referred to as the kernel, and these components are used to manage the hardware and software resources of the device. These resources can include both hardware and software resources for the device; for example, device memory, semaphores, mutexes, chunks, message queues, threads, and device channels. These resources are well known to a person skilled in this art and, therefore, will not be described further in the context of the present invention.

The boundary between the kernel components and the other components on the device is known as the privilege boundary. The kernel provides and controls the way all other software resources stored in the computing device, including client application programs such as for example spreadsheet, word processor, or web browser programs, can access these resources. The kernel components also provide certain services for other parts of the operating system and can, therefore, be contrasted with the outer or shell components of the operating system that interact with user commands.

Most computing devices can only execute one program instruction at a time, but because the devices operate at high speed, they appear to run many application programs and therefore serve many applications simultaneously. To achieve this apparent simultaneous operation, the operating system gives each selected application program a “session” at running on the device, but then requires the selected program to wait while another application program is provided with a session to run on the device. Each of these programs is viewed by the operating system as a task for which certain resources of the computing device are identified and controlled in order to carry out the task. The operating system serves these multiple applications through the use of one or more servers. In this sense, a server may be regarded as a program without a user interface that, to an extent, manages one or more resources of the device. A server will usually provide an application program interface so that client application programmes (also known as clients) can gain access to the services provided by the server. These client applications are not necessarily limited to application programs, but may also include other servers.

Each server generally runs in its own process and the boundary between a server and its respective clients is known as a process boundary. The application programs also run in respective processes, and the boundary between the process of one application and another is also known as a process boundary. Therefore, a process may be regarded as the fundamental unit of protection for the operating system because each process is defined by its own process boundary and these process boundaries can only be crossed under the control of the kernel. Each process for both the servers and the application programs is provided with its own address space in the computing device by the operating system.

Most operating systems for computing devices provide support for both multitasking and multithreading. They also allow multithreading within program processes so that the system is saved the overhead of creating a new process for each thread. In this way, the virtual addresses used by application programs executing in that process may be translated into physical addresses within the read only memory (ROM) or random access memory (RAM) of the computing device. This translation may be managed by a memory management unit, which also forms part of the kernel, so that, for example, read only memory is shared, but the writable memory for use by one process is not normally accessible by another process.

However, for efficient operation of the computing device, sharing of the resources under the control of the kernel is highly desirable. One way in which this can be achieved is by the use of handles. A handle may be regarded as a unique temporary identifier that an operating system assigns to a resource when it is created or opened for use. Processes running in the operating system use handles to refer to resources whenever they need to use them, and a handle remains valid until the resource concerned is either closed or deleted. Many relationships between handles and objects are possible. For example, a handle may be associated with a particular object or a handle may be associated with a number of objects. An individual handle is usually defined so that it is valid for only one application; for example a handle may only be valid with a single thread, or all threads in a single process. It is also possible for a plurality of applications to have their own unique handle to the same resource, or even for multiple unique handles to exist in a single context for the same resource. This can be achieved by opening new handles to an existing named resource, or by duplicating the handle in some way to create a ‘new’ handle.

It is sometimes necessary or beneficial for two or more processes to have access to the same resource, and thus each has its own handle to this resource. Such resource ‘sharing’ enables cooperation between processes or provides more efficient methods for operating. One method for duplicating a handle in order to enable such sharing is for the second process to request a new handle from the kernel, given the identity of the first process and the handle that the first process has to the resource. In practice, the handle is usually a numeric value and thus a malicious program could, by trying all possible handle values, eventually acquire a duplicate handle to every resource used by another process. Thus all resources, including those that were never intended to be shared, are now accessible by a malicious program, which can then prevent the first process from operating correctly. In other words, the operating system can actually lose control of the resources it is required to control in order to ensure continued operation of all applications running on the device.

It is therefore an object of the present invention to provide an improved method for providing handles in a computing device such that resources can be shared between processes in a more secure manner.

According to a first aspect of the present invention there is provided a method of operating a computing device, the method comprising allocating a handle to a process for enabling the process to use a resource allocated to another process, arranging the handle such that the process is not able to identify the resource, and inhibiting further access by the process to the resource after the use of the resource by the process arising from the allocation of the handle has been terminated.

According to a second aspect of the present invention there is provided a computing device arranged to operate in accordance with the method of the first aspect.

According to a third aspect of the present invention there is provided a computer program for causing allocation of handles in a computing device in accordance with the method of the first aspect.

The present invention will now be described, by way of further example only, with reference to a preferred embodiment.

There is a new generation of wireless telephony becoming available which uses third generation protocols that support much higher data rates intended primarily for applications other than voice, such as full motion video, video conferencing and full internet access. This telephony is now becoming known as 3G communications and the wireless communication devices used for this telephony are becoming widely known as smart phones.

Quality of service requirements for 3G communications place response time requirements on the software implementing the communications stacks in the smart phones used to implement these communications. However, it is not generally possible for the operating system server in a smart phone to make response-time guarantees to all of its client applications running on the device.

As an example, all messages, such as SMS, EMS, MMS, e-mail and fax that are to be serviced by a device are handled in strict first-in-first-out (FIFO) order. These different types of messages require their own application programs and each may therefore be regarded as a client for the respective server. However, servers typically have no limit on either the number of connected clients or number of messages waiting to be serviced. The clients being serviced by the device are usually accorded priority; for example an e-mail message may be regarded as having a higher priority than an SMS message. But, in view of the above circumstances, the ‘higher priority’ client may still have to wait for an unbounded time before its request is handled by the device because one or more lower priority clients are queued for service by the device. In this circumstance the only way to use existing client/server code and provide some response time guarantees for the higher priority client is to have a dedicated server for that client. However, in a typical operating system for a wireless communication device, servers are all globally accessible resources and are thus vulnerable to denial of service attacks by rogue applications that attempt to connect to this server through the acquisition of a handle to that server, as outlined previously.

With the present invention, the servers, like any other resource within the device to which the application may be given access, are made less vulnerable to attack by the creation of anonymous servers, whereby the client application is connected to the server using a secure server handle, rather than the actual identity of the server. The dedicated connection between the client application and the server is then set up by using an existing client/server connection to request a dedicated communication channel within the device. When this request is issued, the server creates an anonymous instantiation of the required server, in essence a secure handle, connects a session for the client application to this instantiated server, and then passes the resulting session back to the client application via an open sharing mechanism in the same manner as an ‘open’ handle, as is typical in this art. This provision of an anonymous instantiation of the server allows the server to authenticate any client request for a dedicated communication channel to a resource. Thus, abuse of this provided functionality can be prevented and, furthermore, the benefit provided by this functionality can be removed at any time.

Thus, with the present invention, and using Symbian OS™ APIs as an example, all that is required to pass a file server session back to a client application via an inter process communication (IPC) message in a secure manner is the following code:
RFs fs;
User::LeaveIfError(fs.Connect( ));
User::LeaveIfError(fs.ShareProtected( ));
User::LeaveIfError(message.Complete(fs))

Thus, it can be seen from this code sequence that efficient and robust ‘sharable’ sessions that include sharing across process boundaries can be achieved using the method of the present invention.

With the known way of sharing sessions across a process boundary using handles, sessions and sub-sessions could not escape the process that created them and processes cannot change their security identity or capabilities. Thus, the server could assume that a user of a session or sub-session had the same security attributes as the creator of the session or sub-session.

Therefore, for some operating systems it may be considered inappropriate to provide servers with the ability to support sharable sessions as a default option. In this case the operating system can be arranged to ensure that a server has to explicitly indicate that it can correctly support sessions being transferred across a process boundary before the use of secure handles is enabled. Hence, a server that is able to allow this facility for client applications should preferably be arranged to conduct a series of security checks in order to determine that it can adequately protect itself from a potential rogue client, and also protect clients from each other.

Furthermore, a client application that decides to use this secure handle feature should also preferably be arranged to be aware of security issues. For example, in the case of a shared file server session between two processes, each process would be able to access any files that were opened by the other process on the same session. Hence, it is preferable that such shared sessions should only be used to open the files that are going to be shared during the session concerned. Other files should be opened only when using a completely private session. Alternatively, the file server could be implemented in a way to prevent each process from seeing any other files in the data cage of the other process, even when they use the same session.

Certain applications that carry out electronic transactions on computing devices additionally may require to use custom fonts without compromising security. With these types of applications, the fonts are usually rendered within a server known as the Font-bitmap server, and font-files are kept within the data cage of that server to protect against tampering. Some of these fonts are known as ‘Private trusted’ fonts because they are considered to provide an additional level of security. It follows that the identities of these ‘Private trusted’ fonts need to be kept extremely secure, and in order to ensure that other applications cannot use them they are usually maintained in a file of the data cage of the application concerned.

The font-bitmap server cannot see this data caged file so a way is required to transfer this font file to the server when a transaction occurs. With conventional processing techniques a file handle would not be used to allow the server to have even temporary access to this file. Hence, when such a file is required to be transferred from the application to the server, it does not take place across the process boundary between that application and server. Instead, all communications to transfer this file are routed through the operating system kernel, which is expensive in terms of CPU time, RAM usage and/or file system usage. This can be a severe disadvantage in a computing device having relatively restricted physical resources, such as are typically found in a smart phone. However, using the method of the present invention, the trusted client application can be arranged just to pass a secure file handle and session to the server, and the server can then read the secure file directly from its location in the data cage of the client application without determining the identity of the file. Hence, the secure identity of the file is maintained but improved efficiency of operation for the computing device is provided.

It is well reported that there has been a significant increase in the use of messaging services on mobile communications devices, including smart phones. The operating system for these devices will typically include a message server and a message database is maintained in the data cage of the message server. This database will, typically, also include attachments for communication as part of a message.

When viewing an attachment, the associated application will need to run and access the document contents. However, this application cannot see the file in the message store holding the document concerned. Possible solutions all have significant overheads and drawbacks, particularly when considering particularly large files such as installation packages. These solutions include
Copying the file to a temporary, public location: this is time consuming, wastes file system space and is a security concern.
Transferring the file in a chunk, or in a piecemeal fashion, to the launched application. Again, this is burdensome on time and device memory. Security of the file contents is easier to maintain, but the file transfer is relatively complex to implement effectively.

With the present invention, the application can instead be passed a secure file handle from the message server which does not identify but gives access to the attached document. The application is then able to extract the file content directly and efficiently, but without additional security risks.

The following code exemplifies changes that would be necessary to enable a file server to share file handles in a secure manner using the Symbian OS™ operating system. The code also exemplifies the pattern of usage in client applications. In this operating system a session from an application program to a file server is denoted by the term RFs.

Initially, the file server is arranged to report to the operating system kernel that the session can be shared globally. This is a simple matter of replacing the base-constructor call of the file server CServerFs:
:CServer(aPriority,ESharableSessions)
   with
:CServer(aPriority,EGlobalSharableSessions)

The file server already carries out its security checks in a manner that allows a file server session to be shared safely with another process. In particular, it checks the capability and identity of the requester when carrying out actions like opening files, and does not rely in the session on cached information. Thus, if a process A passes a handle to a file server session to process B, process B can only open files in the data cage of process B, and process A can only open files in the data cage of process B.

However, open sub-session objects can carry out actions which assume the client application has full access rights to the sub-session. In particular, the code RFile::Rename( ) will effectively move the file from the directory it resides in. So, in this instance, the implementation of this code should be accompanied by an extra check to prevent this file movement if the original file is not located in the data cage of the client application requesting the operation. The other file server APIs should also be checked to ensure that there are no other security issues introduced by sharing the sessions.

For completeness, support should also be provided for client applications to be able to pass sub-session handles both cleanly and safely. Suppose that process A has managed to pass the RFs and the RFile::SubSessionHandle( ) to process B. The first concern is that there is no obvious way to set the iSession and iSubSessionHandle of the RFile with the returned RFs and file handle. One simple way to redress this concern is to introduce a simple function to RSubSessionBase that does this:
void RSubSessionBase::Set(const RSessionBase& aSession, TInt aHandle)
   {iSession=aSession;iSubSessionHandle=aHandle;}

However, this then exposes process B to the possibility that process A has passed a garbage value as the sub-session handle and B cannot validate the handle. As soon as B uses the RFile object, it will be paniced by the file server. Instead, the file server should get explicitly involved and support this activity by providing a handle validation for such transfers:
TInt RFile::Adopt(RFs& aFs, TInt aHandle);

This validation functions like the other ‘open’ APIs and establish a ‘new’ sub-session. Inside the file server this function initiates the following process steps:
(a) check that aHandle is a real handle to a file control block in the session provided (if not return KErrBadHandle)
(b) create a new sub-session handle to the same file control block, returning this to the client application
(c) discard the old sub-session handle from the session (this effectively invalidates the old handle)

The reason that the API is framed in terms of ‘transfer ownership’ rather than as ‘duplicate’ is symmetry: the pattern for using it for client-to-server and server-to-client transfer is essentially the same.

If it is desirable to do this for other file server sub-session objects the API could be a generic RFsBase one rather than a RFile one.

The following example demonstrates how a secure file handle according to the present invention may be passed using code, using an API to allow process B to access a file in the data cage of process A. It is assumed that processes A and B have a client/server connection, and the scenarios of A being the client and also of A being the server are presented.

As stated previously, a shared file server session would enable each process to access any files that were opened by the other process on the same session. Hence, the anticipated solution to this concern is to use a dedicated session for each file that is shared. The example set out below does not require process A to maintain an open handle on the file and hence process A can close its session immediately it knows that process B has its own handle to it—this ensures that process A has minimal risk of inadvertently using the session for other activity and accidentally exposing its private data to process B.

In the code example below, the server infrastructure has been omitted to assist clarity, the value EIpcPassFile is the value of the IPC request used in the client/server protocol, and KTheFile is the name of the file.

Examples of code using Symbian OS™ to hand over a file between process A and process B using a secure handle using process A as a client and then as a server could therefore be as follows:

Process A as a Client

Code for Process A:
RFs fs;
User::LeaveIfError(fs.Connect( ));
CleanupClosePushL(fs);
User::LeaveIfError(fs.ShareProtected( ));
RFile file;
User::LeaveIfError(file.Open(fs,KTheFile,EFileWrite));
TInt ssh=file.SubSessionHandle( );
User::LeaveIfError(ipc.SendReceive(EIpcPassFile,TIpcArgs(fs,ssh)));
CleanupStack::PopAndDestroy(&fs);

Code for Process B (use the file synchronously)
RFs fs;
User::LeaveIfError(fs.Open(message,0));
CleanupClosePushL(fs);
RFile file;
User::LeaveIfError(file.Adopt(fs,message.Int1( )));
CleanupClosePushL(file);
// now use the file . . .
CleanupStack::PopAndDestroy(2,&fs);
message.Complete(KErrNone);

Code for Process B (use the file asynchronously)
RFs fs;
User::LeaveIfError(fs.Open(message,0));
CleanupClosePushL(fs);
RFile file;
User::LeaveIfError(file.Adopt(fs,message.Int1( )));
CleanupStack::Pop(&fs);
// now stash fs/file somewhere safe, close them when finished
message.Complete(KErrNone);
   Process A as a Server

Code for process A:
RFs fs;
User::LeaveIfError(fs.Connect( ));
CleanupClosePushL(fs);
User::LeaveIfError(fs.ShareProtected( ));
RFile file;
User::LeaveIfError(file.Open(fs,KTheFile,EFileWrite));
message.WriteL(0,TPckgC<TInt>(file.SubSessionHandle( )));
message.Complete(fs);
CleanupStack::PopAndDestroy(&fs);

Code for Process B
TPckgBuf<TInt>ssh;
TInt h=ipc.SendReceive(EIpcPassFile,TIpcArgs(&ssh));
RFs fs;
User::LeaveIfError(fs.SetReturnedHandle(h));
CleanupClosePushL(fs);
RFile file;
User::LeaveIfError(file.Adopt(fs,ssh( )));
CleanupClosePushL(file);
// now use the file . . .
CleanupStack::PopAndDestroy(2,&fs);

It is possible to use other means to enable a client/server connection to share resources. The method of the present invention may also be applied to kernel resources so that these can be handed over from a parent process to a child process in a secure fashion. The number and type of the resources handed over could be determined by the two processes, so a relatively straightforward API suffices. An example of a suitable API would be as follows:
RProcess::SetParameter(TInt aIndex, RHandleBase aHandle);

This API must be called on a process after it has been created but before it is resumed. This would add the object referred to by the handle to the process environment with the key ‘aIndex’.
RMutex::Open(TInt aArgumentIndex, TOwnerType aType=EOwnerProcess);

Called by the child process to get a handle to the Mutex resource keyed by ‘aIndex’. This can only be called once for each distinct key value. Similar APIs would exist for all resource types that can be shared by this method.

Although the present invention has been described with reference to particular embodiments, it will be appreciated that modifications may be effected whilst remaining within the scope of the present invention as defined by the appended claims.

1. A method of operating a computing device, the method comprising allocating a handle to a process for enabling the process to use a resource allocated to another process, arranging the handle such that the process is not able to identify the resource, and inhibiting further access by the process to the resource after the use of the resource by the process arising from the allocation of the handle has been terminated.

2. A method according to claim 1 wherein the handle is arranged to enable a plurality of resources allocated to the said another process to be used by the process.

3. A method according to claim 1 wherein the handle is arranged to enable a plurality of processes other than the said another process to use the resource allocated to the said another process.

4. A method according to claim 2 wherein the handle is arranged to enable a plurality of processes other than the said another process to use the resource allocated to the said another process.

5. A method according to claim 1 wherein, the resource is selected to comprise at least one of computing device memory, a semaphore, a mutex a chunk, a message queue, a thread, a file, or a device channel.

6. A method according to claim 5 wherein, when the resource comprises a file, the file comprises at least one of a trusted font file or a message attachment file for the said another process.

7. A method according to claim 5 wherein the resource is located in a data cage within the said another process.

8. A method according to claim 1 wherein the process is selected to comprise a file server.

9. A method according to claim 8 wherein the file server is arranged to indicate to a kernel of the operating system for the computing device that it is able to support the use of the resource prior to the allocation of the handle to the server.

10. A method according to claim 8 wherein the said other process is arranged to terminate a communication session with the server upon allocation of the file handle to the server.

11. A method according to claim 1 wherein the said another process comprises a patent process, the process comprises a child process, and the resource comprises a kernel resource for an operating system for the computing device.

12. A method according to claim 1 wherein the handle is provided as an anonymous instantiation of a server required to access the resource.

13. A computing device arranged to operate in accordance with a method as claimed in claim 12.

14. A computing device according to claim 13 comprising a wireless communication device.

15. Computer software for causing a computing device to operate in accordance with a method as claimed in claim 1.
